(19) United States
(12) Patent Application Publication
(10) Pub. No.: US 2002/0103685 A1
(43) Pub. Date: Aug. 1, 2002

(54) Shipped product allocating system and method, and program and recording medium therefor

(75) Inventor: Yukio Murata, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/058,989

(22) Filed: Jan. 30, 2002

(30) Foreign Application Priority Data
Jan. 31, 2001 (JP) 2001-024773

(51) Int. Cl. G06F 17/60

(52) U.S. Cl. 705/7

(57) ABSTRACT

A shipped product allocating system and method for allocating shipped products, and a program and a recording medium therefor are disclosed. According to the invention, the allocation in a limited priority order of a specific event such as the generation of order information or delivery time in the prior art is eliminated while, at the same time, an allocation meeting the customer demand for a last-minute order change, or an order addition, can be realized. The method comprises the steps of inputting the demand information or the order information, classifying the demand information or the order information into a plurality of groups for allocation, and allocating the shipped products in a predetermined order of priority in each of the groups, and reallocating the allocated products for each customer in a predetermined priority order.

### BACKGROUND OF THE INVENTION

1. Field of the Invention

The present invention relates to a shipped product allocating system and method and to a program and a recording medium therefor.

2. Description of the Related Art

In the conventional method of allocating products to be shipped, the order information is arranged in order of a specific limited event such as the generation of the order information or the delivery date desired by each customer, and products in stock and products to be delivered are allocated accordingly.

As a result, the problem has often been posed that the delivery notification is considerably changed by a last-minute order change, or the allocated delivery time is extremely delayed by an order addition, thereby leading to a deteriorated customer service.

### SUMMARY OF THE INVENTION

This invention is intended to obviate these problems, and the object thereof is to provide a shipped product allocating system and method, and a program and a recording medium therefor, and therefore the object of the present invention is to eliminate the allocation in order of a specific limited event such as the chronological order of the order information generation or the delivery time as in the prior art, and at the same time to realize an allocation meeting customer demand for a last-minute order change or an order addition.

In order to achieve this object, according to one aspect of the invention, there is provided a shipped product allocating system and method, in which the demand information and the order information are classified into allocating groups by a processing unit in accordance with a program, reallocation of the shipped products for each customer is made after allocating them in each of the groups.

The processing unit fetches the demand information or the order information that have been input and classifies them into allocating groups, and after allocating the shipped products in a predetermined order, as the case may be, in each group, reallocates them by customer in the predetermined order.

In the process, a plurality of the groups into which the demand information or the order information are classified include an in-shipment group, a confirmed delivery time group and a unconfirmed delivery time group.

Also, the shipped products are allocated in each group in order of delivery time or quantity.

Further, the shipped products are allocated for each customer in order of delivery time.

Thus, a plurality of demand information or order information are classified into a plurality of groups, and after allocation in each group, reallocated by customer. In this way, the allocation in order of a specific limited event such as the generation of the order information or the delivery time according to the prior art is eliminated, while at the same time realizing an allocation meeting the customer demand for a last-minute order change or an order addition.

### BRIEF DESCRIPTION OF THE DRAWINGS

FIG. 1 is a diagram showing a system configuration according to this invention.

FIG. 2 is a flowchart (for the whole process) for explaining the operation according to the invention.

FIG. 3 is a flowchart (for the demand information) for explaining the operation according to the invention.

FIG. 4 is a flowchart (for the order information) for explaining the operation according to the invention.

FIG. 5 shows an example of classification into groups, in which

FIG. 5A is a diagram showing an example of the order information and the demand information after the preceding allocation,

FIG. 5B is a diagram showing an example of the result of the preceding allocation,

FIG. 5C is a diagram showing an example of the changed information of the demand information and the order information, and

FIG. 5D is a diagram showing a state after grouping.

FIG. 6 is a diagram for explaining the allocation according to the invention, in which

FIG. 6A is a diagram showing an example of grouping,

FIG. 6B is a diagram showing an example of the original stock information for allocation,

FIG. 6C is a diagram showing the state after allocation by group,

FIG. 6D is a diagram showing an example of the original stock information by customer,

FIG. 6E is a diagram showing an example of reallocation by customer, and

FIG. 6F is a diagram showing an example of allocation result.

FIG. 7 is diagram for explaining the concept of the invention.

### DESCRIPTION OF THE PREFERRED EMBODIMENTS

Embodiments of the invention and the operation thereof will be described in detail, below, and one by one with reference to the accompanying drawings.

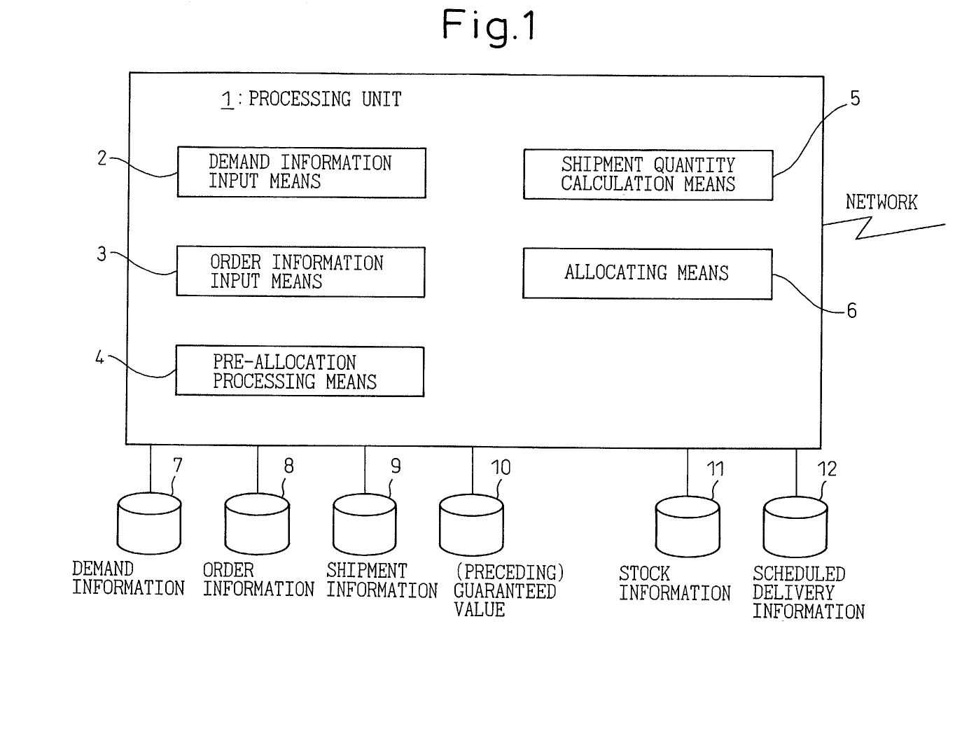

FIG. 1 is a diagram showing a system configuration according to the invention.

In FIG. 1, a processing unit 1 classifies the demand information and the order information into groups followed by the allocation in each group in accordance with a program, and after the allocation, reallocates them by customer. The processing unit 1 includes demand information input means 2, order information input means 3, pre-allocation processing means 4, shipment quantity calculation means 5 and allocating means 6.

The demand information input means 2 is for inputting the demand information on a given customer (the demanded weekly amount of an item, for example), and is supplied with (retrieves), as an example, the customer demand information input and transmitted thereto by way of a terminal, a distributor or an agent through a network.

The order information input means 3, on the other hand, is for inputting the formal order information of a customer, and supplied with (retrieves), as an example, the formal order information of the customer input and transmitted thereto by a terminal of a distributor or an agent through a network.

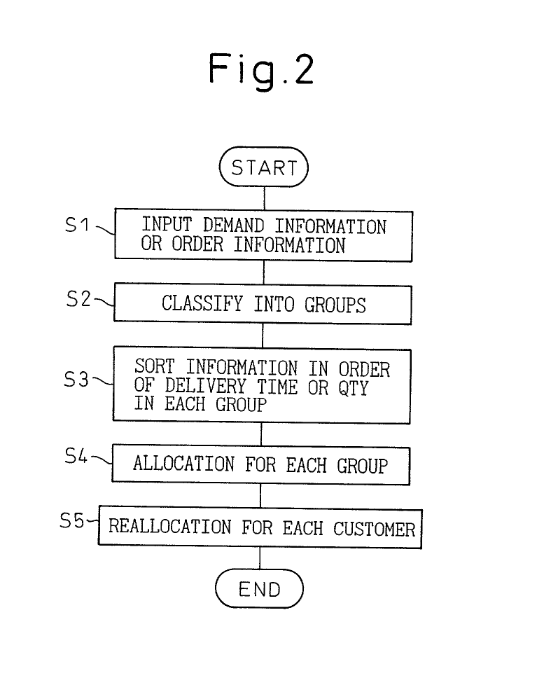

The pre-allocation processing means 4 classifies the input demand information and the input order information into a given one of the groups (as will be described again with reference to FIGS. 2 to 4) for allocation.

The shipment quantity calculation means 5 is for calculating the shipment quantity based on the demand information and the order information.

The allocating means 6 is for allocating the shipped products first in a group, and then reallocating them by customer (as will be described later with reference to FIGS. 2 and 5 to 7).

A demand information file 7 is for storing the demand information by customer or, for example, the predicted demanded quantity of a given item for the week for each customer.

An order information file 8 is for storing the formal order information from the customer.

A shipment information file 9 is for storing the shipment information (shipment quantity of each item, for example) calculated based on the demand information 7 and the order information 8.

A guaranteed value (preceding allocation) file 10 is for storing the preceding allocation (preceding guaranteed value) of the demand information 7 of the customer.

A stock information file 11 is for storing the stock information for each item.

A scheduled delivery information file 12 is for storing the information on the scheduled delivery of an item produced in a production system.

Now, the operation of the whole system will be explained with reference to the flowchart of FIG. 2.

FIG. 2 is a flowchart (for the whole system) for explaining the operation according to the invention.

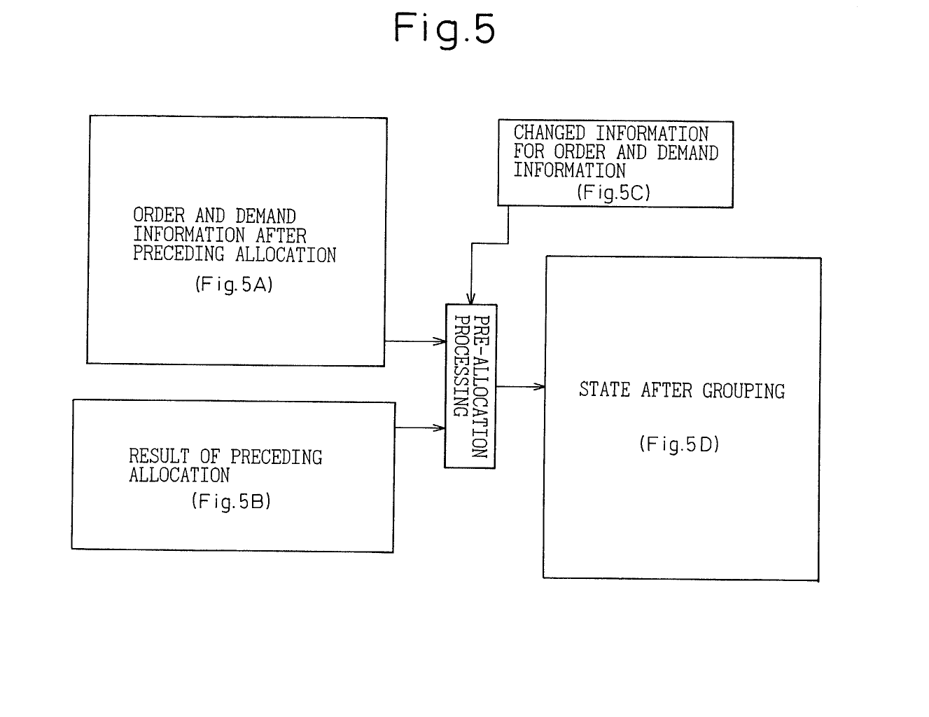

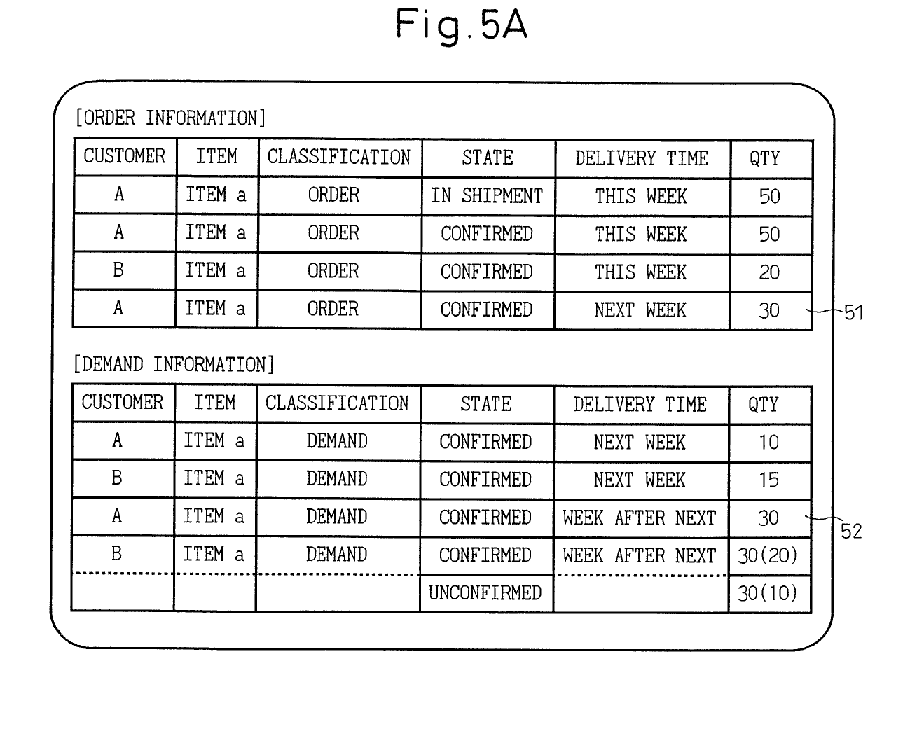

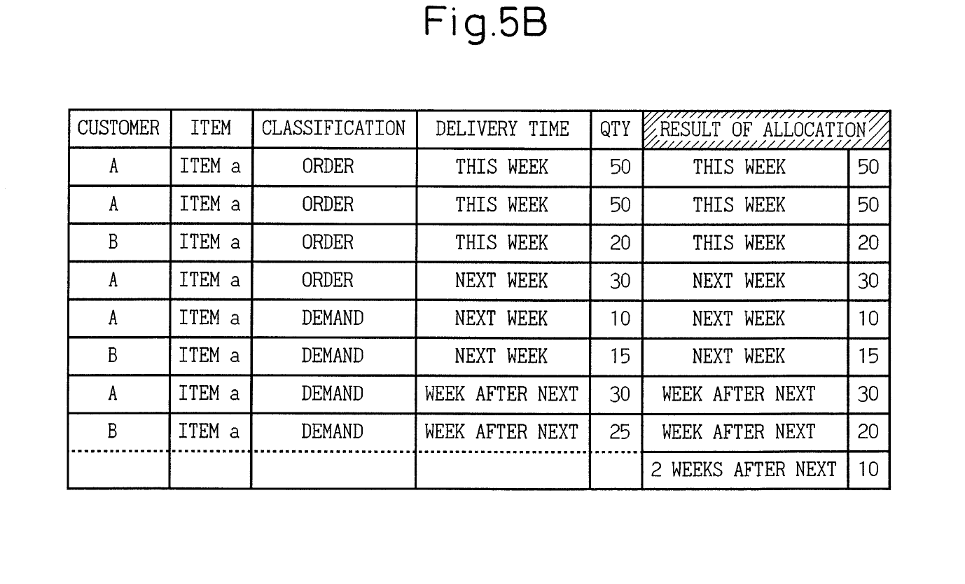

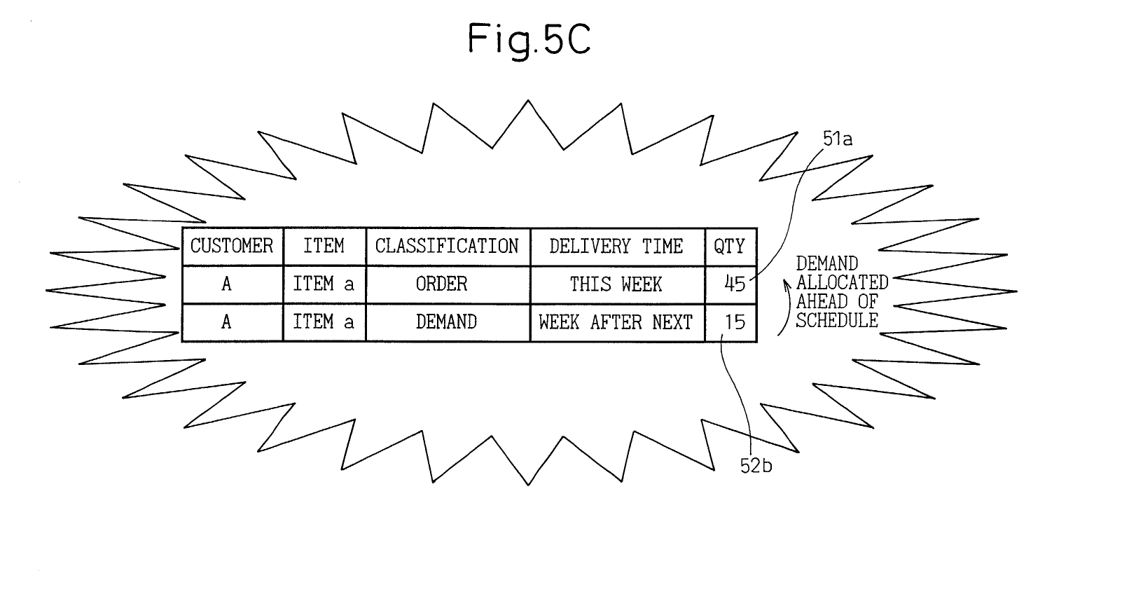

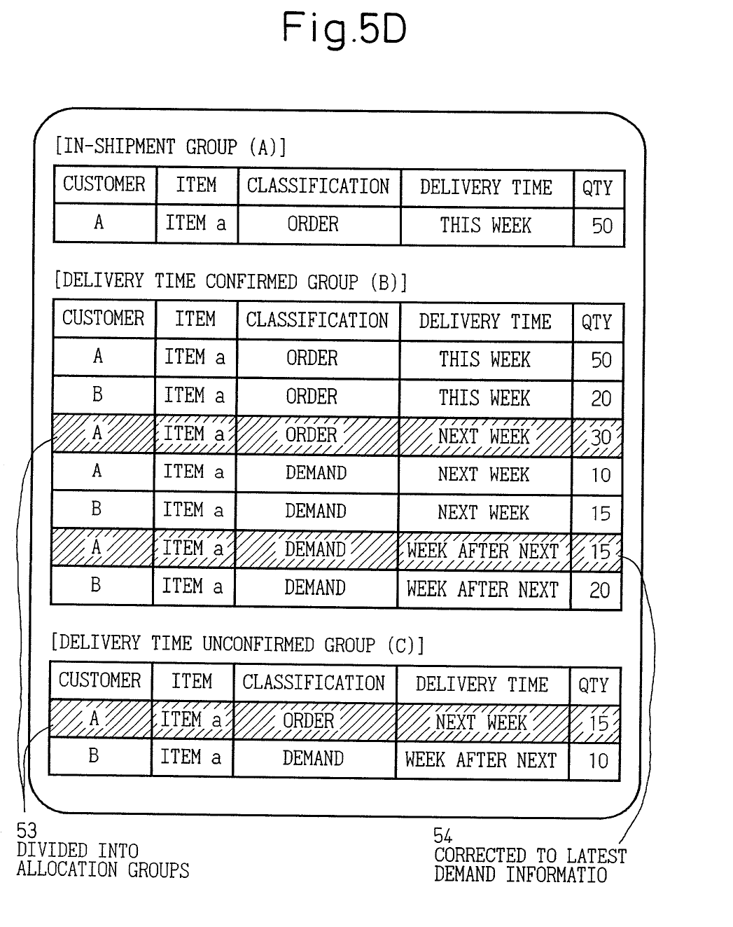

In FIG. 2, the demand information and the order information are input in step S1. Specifically, the demand information 7 and the formal order information of the customer are input (retrieved) through the demand information input means 2 and the order information input means 3 shown in FIG. 1. The demand information and the order information shown in FIG. 5A and described later are also input (retrieved).

In step S2, the information are classified by group. In this process, the demand information 7 and the order information 8 input in step S1 are sorted (classified) into any of three groups including an in-shipment group A, a confirmed group B and an unconfirmed group C, for example, as shown in FIG. 5D.

In step S3, the information are sorted in each group in order of delivery time and quantity. Specifically, as shown in FIG. 5D and described later, for example, the information, after being classified into the in-shipment group A, the confirmed group B and the unconfirmed group C in step S2, sorted in order of delivery time or, for the same delivery time, in the ascending order of quantity.

In step S4, the shipped products are allocated in each group. Specifically, the information, which have been sorted in order of delivery time or in the ascending order of quantity in step S3 in each group, are sorted for allocating the original stock information in each group.

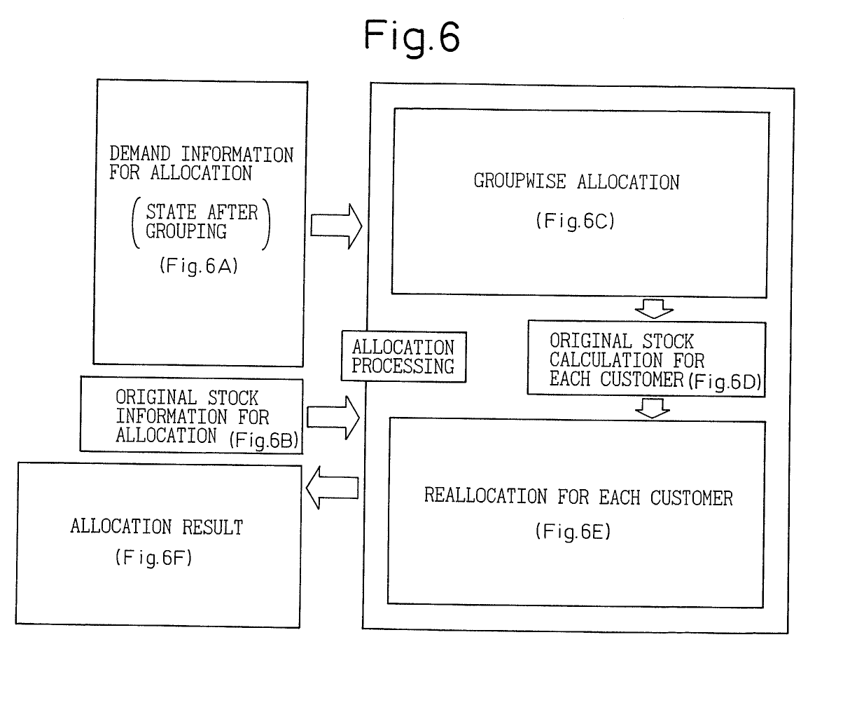

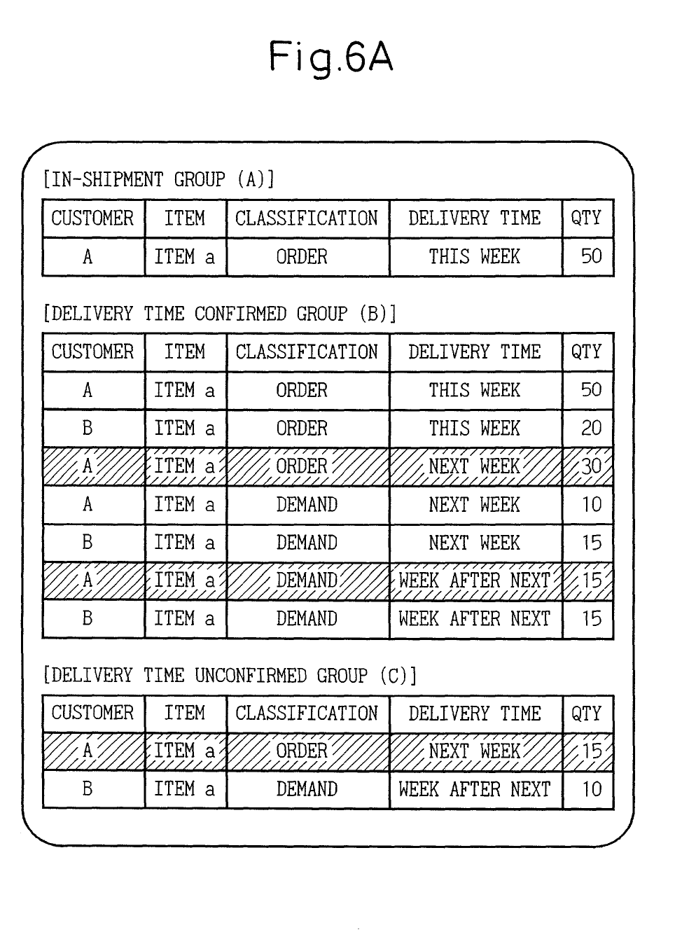

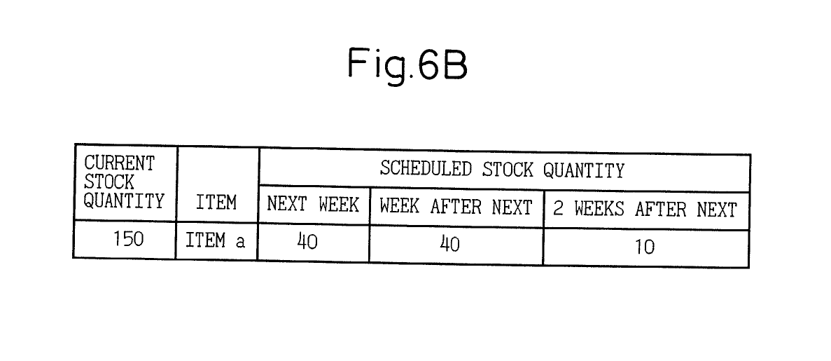

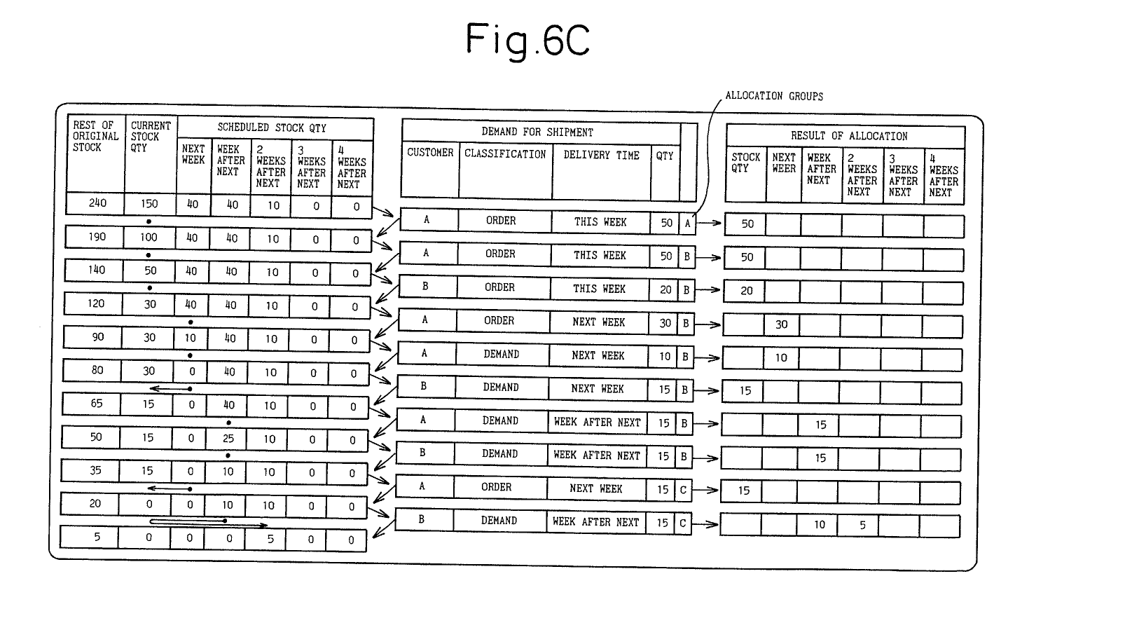

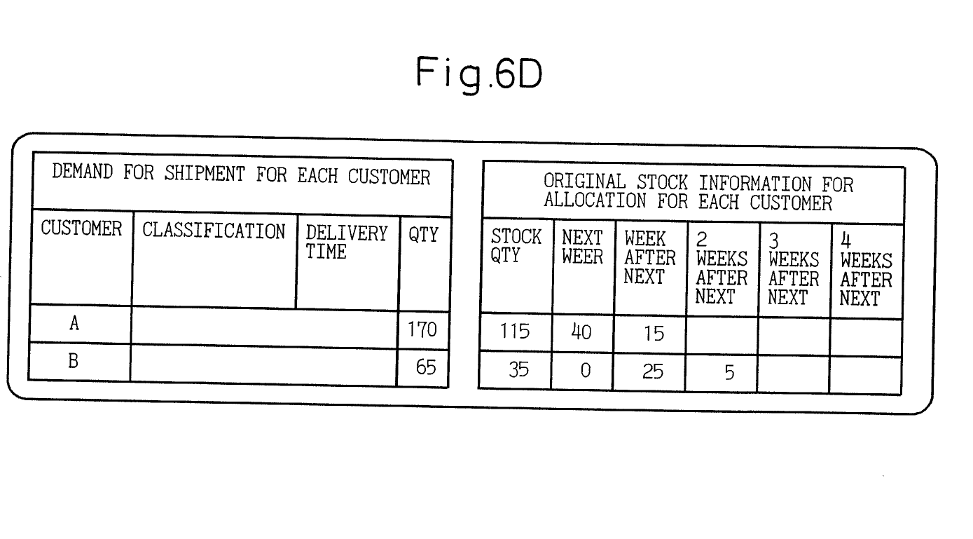

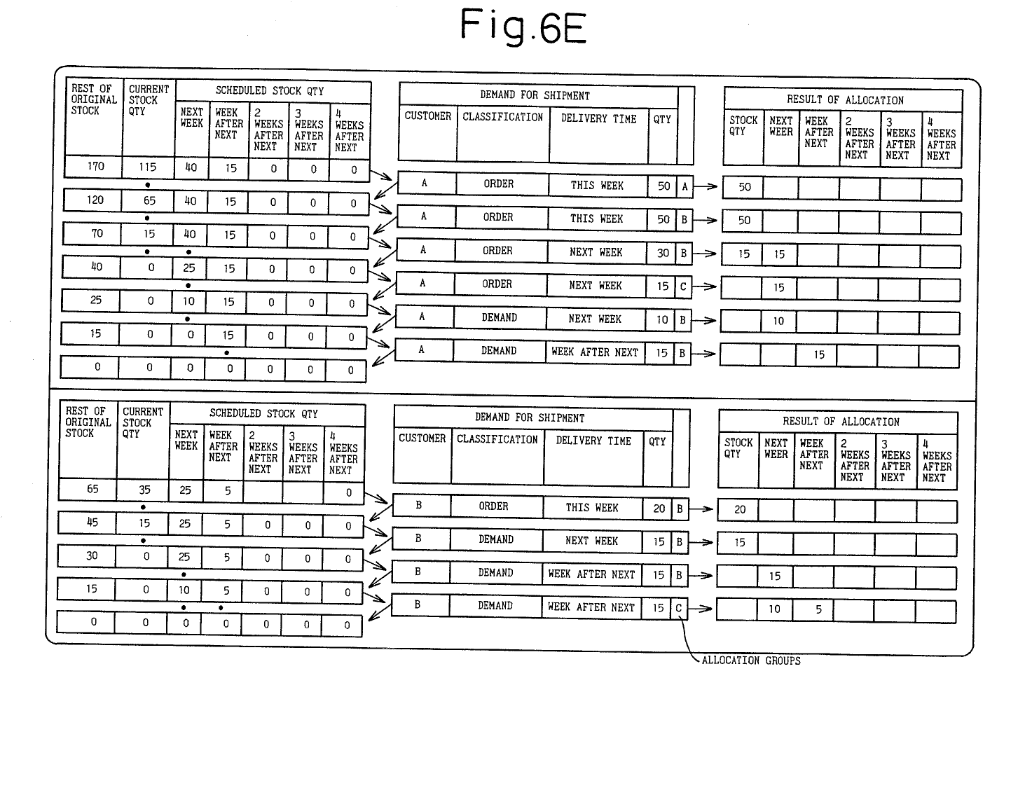

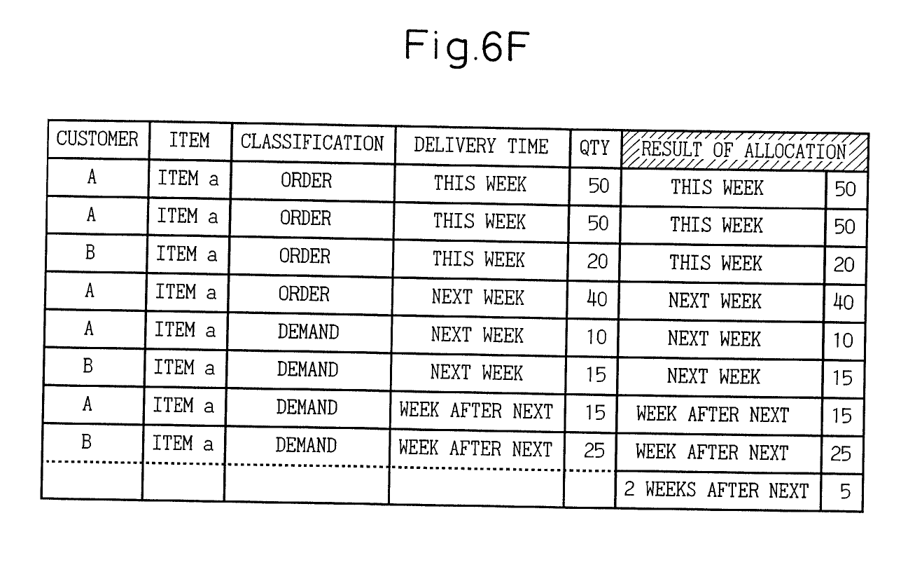

In step S5, the information are reallocated for each customer. Specifically, after the shipped products are allocated for each group in step S4, the allocation for the customers are retrieved from all the groups, and reallocated, for example, by sorting the shipped products for each customer in order of delivery time (see FIGS. 6D and 6E as described later).

As described above, the demand information and the order information of the customers are classified into groups (groups A, B and C, for example) and the shipped products are allocated in each group (in order of delivery time and in the ascending order of quantity, for example), after which the shipped products are reallocated for each customer (in order of delivery time). In this way, the allocation in order of a specific limited event such as the generation of the order information or the delivery time as in the prior art is eliminated, while at the same time realizing the allocation meeting the customer demand for a last-minute order change or an order addition. Explanations will be made, below, one by one.

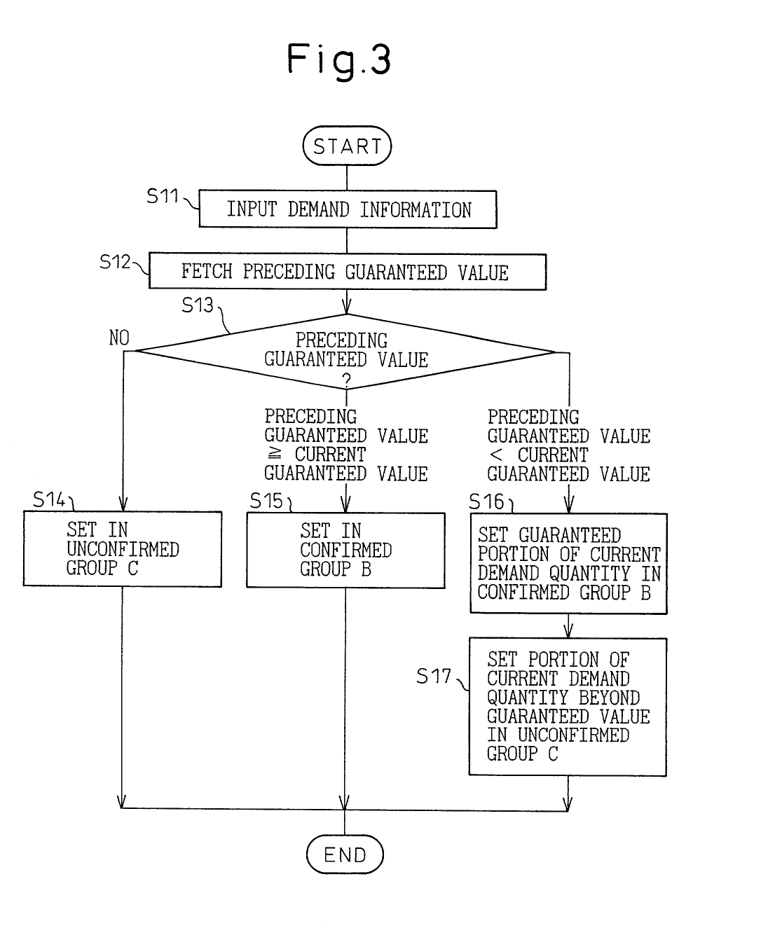

FIG. 3 is a flowchart for the grouping procedure (of the demand information) according to this invention.

In FIG. 3, the demand information are input in step S11. In step S12, the preceding guaranteed value is retrieved.

In step s13, one of the following states is selectively determined:

No preceding guaranteed value

Preceding guaranteed value≧current demanded quantity

Preceding guaranteed value<current demanded quantity

In the absence of the preceding guaranteed value, it is determined that the particular information is the unconfirmed demand information lacking the preceding guaranteed value, and therefore the process proceeds to step S14, where the information is sorted (classified) as an unconfirmed group.

In the case where it is determined in step S13 that the preceding guaranteed value is not smaller than the current demanded quantity (i.e. it is determined that the preceding guaranteed value is confirmed and smaller than the current demanded quantity), on the other hand, the process proceeds to step S15 in which the portion of the current demanded quantity corresponding to the guaranteed value is classified as the confirmed group B, and the process proceeds to step S17.

In step S17, the portion of the current demanded quantity exceeding the guaranteed value is classified as the unconfirmed group C. A given demanded quantity, if larger than the preceding guaranteed value, is sorted into two groups (the confirmed group B and the unconfirmed group c) in steps S16 and 17 for allocation in each of the groups. The shipped products are thus reallocated in order of delivery time for each customer, so that the allocation meeting the customer demand for a last-minute order change or an order addition can be realized.

As described above, the demand information of the customers can be classified into the unconfirmed group C and the confirmed group B in each of the cases where there is no guaranteed value, the demanded quantity is smaller than the preceding guaranteed value and the demanded quantity exceeds the preceding guaranteed value.

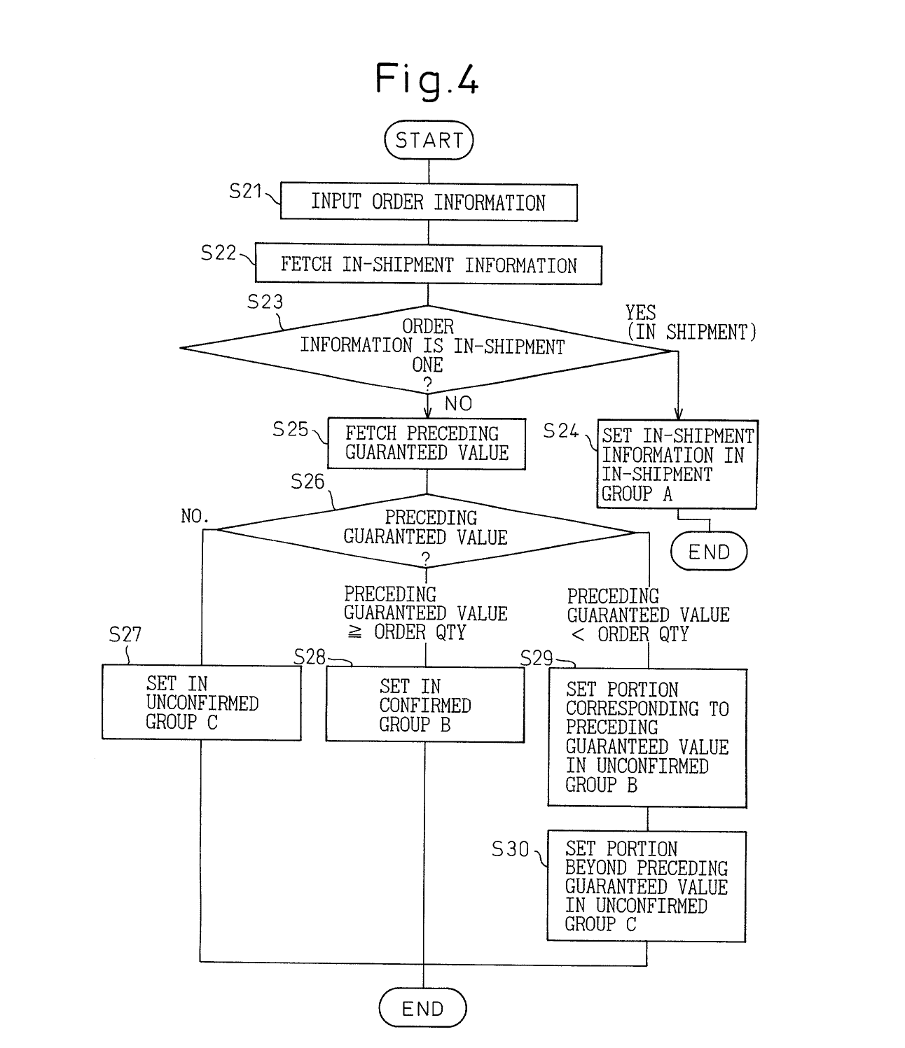

FIG. 4 is a flowchart showing the grouping procedure (for the order information) according to this invention.

In FIG. 4, the order information is input in step S21. In step S22, the in-shipment information is retrieved.

In step S23, it is determined whether the product covered by the particular order information is in shipment or not. In the case where the answer is YES, it is determined that the ordered product is in shipment, and therefore the order information is classified as the in-shipment group A in step S24. In the case where the answer is NO, on the other hand, the process proceeds to step S25.

In step S25, the preceding guaranteed value is fetched. In step S26, one of the following states is selectively determined:

No preceding guaranteed value

Preceding guaranteed value≧current demanded quantity

Preceding guaranteed value<current demanded quantity

In the case where it is determined in step S26 that there is no preceding guaranteed value (i.e. the particular order information is not accompanied by any preceding guaranteed value and is determined as the unconfirmed order information), the process proceeds to step S27, where the particular order information is classified as the unconfirmed group C.

In the case where it is determined in step S26 that the preceding guaranteed value is larger than the quantity in the current order information (i.e. it is determined that the preceding guaranteed value is confirmed and equal to or larger than the quantity in the current order information), then the process proceeds to step S28 and the particular order information is classified as the confirmed group B.

In the case where it is determined in step S26 that the preceding guaranteed value is smaller than the quantity in the current order information (i.e. it is determined that the preceding guaranteed value is confirmed and smaller than the quantity in the current order information), the process proceeds to step S29 and the portion of the current order information corresponding to the guaranteed value is classified as the confirmed group B, followed by proceeding to step S30.

In step S30, the portion of the current order information that exceeds the guaranteed value is classified as the unconfirmed group C. A given piece of order information, if larger than the preceding guaranteed value, is classified into two groups (the confirmed group B and the unconfirmed group C) and the shipped products are allocated respectively in steps S29 and 30. The shipped products are thus reallocated in order of delivery time for each customer, thereby making it possible to realize the allocation meeting the customer demand for a last-minute order change or an order addition.

As described above, the formal order information of the customer can be classified into the in-shipment group A, the unconfirmed group C, the confirmed group B and the unconfirmed group C in the cases where the ordered products are in shipment, there is no preceding guaranteed value, the order information is less than the preceding guaranteed value and the order information exceeds the preceding guaranteed value, respectively.

FIG. 5 shows an example of the grouping procedure according to this invention.

FIG. 5A shows an example of the order information and the demand information after the preceding allocation. The upper part of the drawing represents an example of the order information after the preceding allocation, and the lower part an example of the demand information after the preceding allocation. In both cases, the following information are registered with corresponding facts:

Customer name:

Item:

Classification: Order or demand

State: In shipment, confirmed, unconfirmed

Delivery time: This week, next week, week after next, etc.

Quantity:

FIG. 5B shows an example of the preceding allocation. This is the result of the preceding allocation of the preceding order information and the demand information shown in FIG. 5A, and the following information is registered with corresponding facts:

customer name:

Item:

Classification: Order or demand

Delivery time: This week, next week, week after next

Quantity:.

Result of allocation: 50 for this week, etc.

FIG. 5C shows an example of the changed information for the order information and the demand information. In his example, the changed information is obtained by changing the quantity 30 of the preceding order information indicated by arrow 51 in FIG. 5A to 45, and the quantity 30 of the preceding demand information indicated by arrow 52 in FIG. 5A to 15.

FIG. 5D shows the state after the grouping process. Of the quantity 45 indicated by arrow 51a in FIG. 5C, 30 are confirmed already (corresponding to the portion of the order information indicated by arrow 51 in FIG. 5A) and belong to the delivery time confirmed group B (step S29 in FIG. 4 described above), while 15 are unconfirmed and belong to the delivery time unconfirmed group C (step S30 in FIG. 4 descried above). Therefore, the particular order information are divided and classified to the respective groups as shown. On the other hand, the changed information indicated by arrow 52A are the confirmed (having the preceding guaranteed value) demand information indicated by arrow 52 in FIG. 5A, and therefore are corrected to the latest demand information (from 30 to 15) in the entry of the delivery time confirmed group B indicated by arrow 54 in FIG. 5D. The remaining 15 after the correction are used for processing of the other demand information ahead of schedule.

As described above, the changed order information 51a and the changed demand information 52a of FIG. 5C, once input, are classified into the related groups as indicated by arrows 53 in FIG. 5D thereby to reflect the order information and the demand information, respectively (see the flowcharts of FIGS. 3 and 4).

FIG. 6 is a diagram for explaining the allocation according to this invention.

FIG. 6A shows the same state of grouping as FIG. 5D described above, in which the order information and the demand information (including the changed information) are classified into three groups A, B and C (the halftone dotted portions correspond to the changed information).

FIG. 6B shows an example of the original stock information.

FIG. 6C shows the state after allocation by group. This groupwise allocation represents the state after allocating the original stock of FIG. 6B in order of priority (in chronological order of delivery time or, for the same delivery time, in ascending order of quantity) in each of the allocation groups for the portions A, B and C (groups A, B and C) in that order.

FIG. 6D shows an example of the original stock information by customer. This represents the state in which the stock is allocated for each group in FIG. 6C, and totalized for each customer to determine the original stock information for each customer.

FIG. 6E shows an example of the reallocation by customer. With the stock allocated for each group in FIG. 6C, all the information are retrieved and sorted in order of delivery time and group (groups A, B and C in that order) for each customer. Thus, the original stock are reallocated for each customer as shown in FIG. 6D.

FIG. 6F shows an example of the result of allocation. This represents the totalization of the result of allocation after reallocation by customer in FIG. 6E.

As described above, the order information and the demand information (including the changed information) are classified by group as shown in FIG. 6A, the shipped products are allocated for each group (FIG. 6C), and then reallocated by customer (FIG. 6E), thereby making it possible to generate the result of allocation (FIG. 6F).

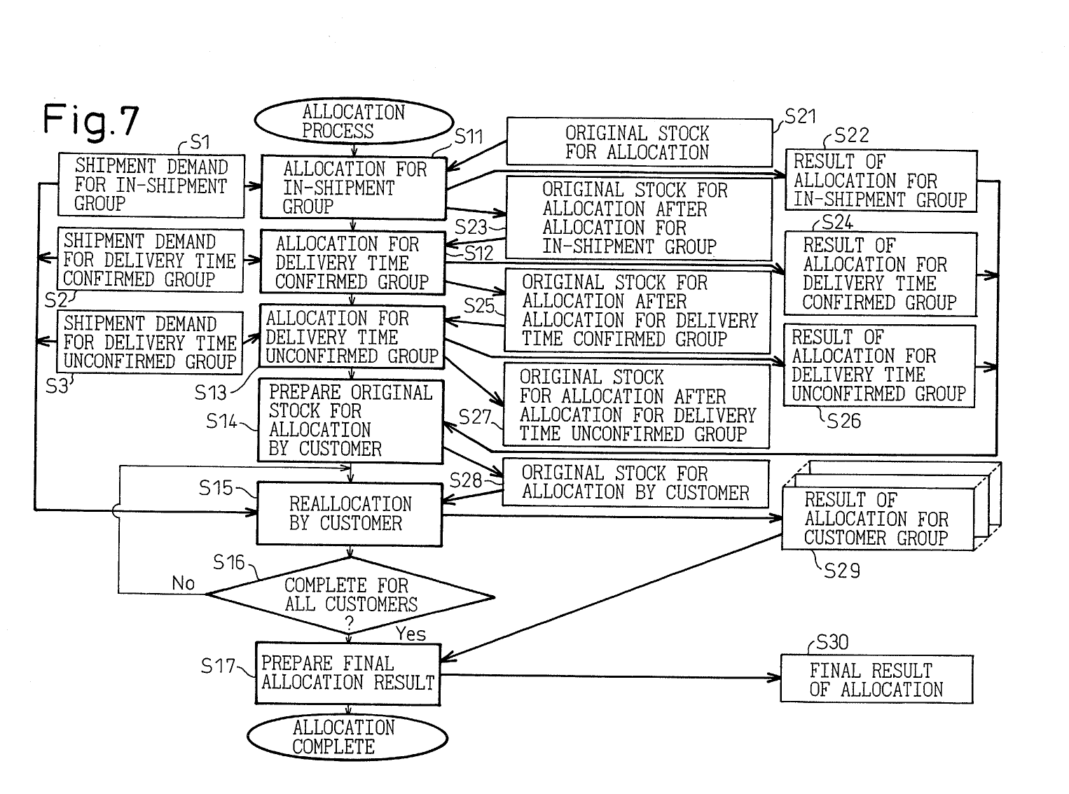

FIG. 7 is a diagram for explaining the concept of the invention.

In FIG. 7, the shipment demand for the in-shipment group is designated in step S1. This represents the shipment demand for the in-shipment group A described above.

In step S2, the shipment demand for the delivery time confirmed group is designated. This represents the shipment demand for the delivery time confirmed group B described above.

In step S3, the shipment demand for the delivery time unconfirmed group is designated. This represents the shipment demand for the delivery time unconfirmed group C described above.

In step S11, the in-shipment group is allocated. This represents the allocation, in the particular in-shipment group, of the original stock information input in step S21, with regard to the shipment demand of the in-shipment group of step S1, in order of a predetermined priority (in order of delivery time, or for the same delivery time, in ascending order of quantity, for example). Then, the result of allocation of the in-shipment group in step S22 (the entry of the allocation group A in the groupwise allocation of FIG. 6B described above, for example) is output, while at the same time outputting the original stock information after allocation of the in-shipment in-allocation group in step S23.

In step S12, the delivery time confirmed group is allocated. This represents the allocation of the original stock information in order of predetermined priority (in order of delivery time, or for the same delivery time, in the ascending order of quantity) in the particular delivery time confirmed group with regard to the shipment demand of the delivery time confirmed group of step S2 after allocation of the in-shipment group in step S23. Then, the result of allocation of the delivery time confirmed group in step S24 (the entry of the allocation group B in the groupwise allocation of FIG. 6B described above, for example) is output while at the same time outputting the original stock information after allocation of the delivery time confirmed group in step S25.

In step S13, the delivery time unconfirmed group is allocated. This represents the allocation of the original stock information, after allocation of the delivery time confirmed group in step S25, in order of predetermined priority (in order of delivery time, or for the same delivery time, in ascending order of quantity) in the delivery time unconfirmed group of step S3 with regard to the shipment demand of the particular delivery time unconfirmed group. Then, the result of allocation of the delivery time unconfirmed group in step S26 (the entry of the allocation group C in the groupwise allocation of FIG. 6E described above, for example) is output, while at the same time outputting the original stock information after allocation of the delivery time unconfirmed group in step S25.

In step S14, the original stock information of allocation by customer is prepared. This concerns the totalization of all the original stock information allocated to each customer from the result of allocation in steps S22, S24 and S26, and the preparation of the original stock information for allocation by customer (as shown in FIG. 6D, for example) in step 28.

In step S15, the reallocation is carried out for each customer. This represents the preparation of a customer group by extraction the information for each customer in steps S22, S24 and S26, the reallocation (in order of delivery time, for example) of the original stock information by customer in step S28 for each customer group, and the outputting of the result of the customer group allocation in step S29.

In step S16, it is determined whether the information processing for all the customers is complete or not. In the case where the answer is affirmative, the process proceeds to step S17. If the answer is negative, on the other hand, the process is returned to step S15 for repeating the process.

In step S17, the final allocation result is prepared. This represents the totalization of the allocation result for the customer group of all the customers in step S29 and the outputting of the result of the final allocation and totalization in step S30 (as shown in FIG. 6F described above, for example).

As described above, for the in-shipment group shipment demand (S1), the delivery time confirmed group shipment demand (S2) and the delivery time unconfirmed group shipment demand (S3), extracted from the demand information and the order information, the in-shipment group A, the delivery time confirmed group B and the delivery time unconfirmed group C, respectively, shipped products are allocated in that order each in order of priority (in order of delivery time, or in the ascending order of quantity for the same delivery time), and after the allocation, the original stock information are totalized by customer. With this as original stock information for each customer, the shipped products are reallocated for each customer in order of priority (in order of delivery time, for example) thereby to obtain the final allocation result. In this way, the allocation in order of a specific event such as the generation of the order information or the delivery time in the prior art can be eliminated, while at the same time making it possible to realize the allocation meeting the customer demand even for a last-minute order change or an order addition.

In spite of the foregoing description that the information are divided into three groups including the in-shipment group A, the delivery time confirmed group B and the delivery time unconfirmed group C, the invention is not limited to the three groups but the information can be classified into any plurality of groups. Also, the groups into which the information are classified are not necessarily limited to the in-shipment group, the delivery time confirmed group and the delivery time unconfirmed group, but the information may alternatively be classified into groups in accordance with the customer type or product type such as the degree of customer importance or vendor characteristic (ease to acquire) of a product item, as well as the in-shipment state, the confirmed delivery time or the unconfirmed delivery time.

It will thus be understood from the foregoing description that according to this invention, there is provided a shipped product allocating system and method, in which a plurality of the demand information and the order information are classified into a plurality of groups, and after allocating the shipped products in each group, the shipped products are reallocated by customer. Thus, the allocation in order of a specific event such as the generation of the order information or the delivery time as in the prior art is eliminated, while at the same time making it possible to realize an allocation meeting the customer requirement for a last-minute order change or an order addition for an improved customer service.

What is claimed is:

1. A shipped product allocating system for allocating shipped products, comprising:
means for inputting selected one of the demand information and the order information through demand input means or order input means, as the case may be;
means for classifying selected one of the demand information and the order information input through said input means into a plurality of predetermined groups for allocation;
means for allocating said shipped products in a predetermined order of priority within each of said groups; and
means for reallocating said shipped products after allocating them in a predetermined order of priority for each customer.

2. A shipped product allocating method for allocating shipped products, comprising the steps of:
inputting a selected one of the demand information and the order information;
classifying a selected one of the demand information and the order information input by said input means into a plurality of predetermined groups for allocation;
allocating said shipped products in a predetermined order of priority within each of said groups; and
reallocating said shipped products after allocating them in a predetermined order of priority for each customer.

3. A shipped product allocating method according to claim 2, wherein said plurality of groups include an in-shipment group, a confirmed delivery time group and an unconfirmed delivery time group.

4. A shipped product allocating method according to claim 2, wherein said predetermined order of priority in each of said groups includes the order of delivery time and the order of quantity.

5. A shipped product allocating method according to claim 3, wherein said predetermined order of priority in each of said groups includes the order of delivery time and the order of quantity.

6. A shipped product allocating method according to claim 2, wherein said predetermined order of priority for each customer includes the order of delivery time.

7. A shipped product allocating method according to claim 3, wherein said predetermined order of priority for each customer includes the order of delivery time.

8. A shipped product allocating method according to claim 4, wherein said predetermined order of priority for each customer includes the order of delivery time.

9. A shipped product allocating method according to claim 5, wherein said predetermined order of priority for each customer includes the order of delivery time.

10. A shipped product allocating program for allocating shipped products, causing a computer to function as:
means for inputting a selected one of the demand information and the order information;
means for classifying a selected one of the demand information and the order information input through said input means into a plurality of predetermined groups for allocation;
means for allocating said shipped products in a predetermined order of priority within each of said groups; and
means for reallocating said shipped products, after allocating them in a predetermined order of priority for each customer.

11. A shipped product allocating program according to claim 10, wherein said plurality of groups include an in-shipment group, a confirmed delivery time group and an unconfirmed delivery time group.

12. A shipped product allocating program according to claim 10, wherein said predetermined order of priority in each of said groups includes the order of delivery time and the order of quantity.

13. A shipped product allocating program according to claim 10, wherein said predetermined order of priority for each customer includes the order of delivery time.

14. A computer readable recording medium for recording a program for allocating shipped products, wherein the program causes a computer to function as:
means for inputting a selected one of the demand information and the order information;
means for classifying a selected one of the demand information and the order information input through said input means into a plurality of predetermined groups for reallocation;
means for allocating said shipped products in a predetermined order of priority within each of said groups; and
means for reallocating said shipped products after allocating them in a predetermined order of priority for each customer.

15. A computer readable recording medium according to claim 14, wherein said plurality of groups include an in-shipment group, a confirmed delivery time group and an unconfirmed delivery time group.

16. A computer readable recording medium according to claim 14, wherein said predetermined order of priority in each of said groups includes the order of delivery time and the order of quantity.

17. A computer readable recording medium according to claim 14, wherein said predetermined order of priority for each customer includes the order of delivery time.
